(19) United States
(12) Patent Application Publication
(10) Pub. No.: US 2009/0252838 A1
(43) Pub. Date: Oct. 8, 2009

(54) Chocolate brittle

(76) Inventor: Rebecca A. Campbell, Centerville, VA (US)

Correspondence Address: Rebecca Campbell, 14209 Glade Spring Dr., Centerville, VA, 10121, US

(21) Appl. No.: 12/385,288

(22) Filed: Apr. 3, 2009

Related U.S. Application Data
(60) Provisional application No. 61/064,965, filed on Apr. 4, 2008.

(51) Int. Cl. A23G 1/30; A23G 1/32; A23G 1/54

(52) U.S. Cl. 426/94; 426/549; 426/558; 426/292

(57) ABSTRACT

Chocolate brittle containing chocolate and syrup is a brittle confection which may, additionally, have other flavorings and toppings added thereto.

This application takes priority from provisional application 61/064,965 filed Apr. 4, 2008.

### BACKGROUND AND FIELD OF THE INVENTION

This invention relates to preparation of desserts or snack items which are thin and brittle and contain chocolate and syrup. The chocolate is in the batter of the basic crisp base, not a covering or separate layer.

Rich cake-like bars containing chocolate are common, as is peanut brittle, which is a candy. Some confections and baked dessert items also containing syrup and some chocolate are known. However, the consistency of the prior art dessert items differ from the consistency and structure of the products of the invention disclosed herein.

Disclosures of cookies and confections containing chocolate which are crisp (at least in part) are found in the patent literature. Many of them are layered. (They do not have the crisp base of the invention).

U.S. Pat. No. 4,455,333 to Hong, et al. discloses cookies having a crisp exterior and chewy interior. The cookies are made by manipulation of the sugar crystallization. The cookies do not have the over-all brittle consistency of the brittle described herein.

U.S. Pat. No. 4,707,365 to Haynes, et al. describes a chocolate product which is appropriate for coating cookies such as those of Hong. et al. The products of Haynes have a chewy interior and a more crisp out surface.

U.S. Pat. No. 7,022,362 to Rabinovitch, et al. describes a confection which may contain chocolate that is made of three layers. No brittle as taught in the instant application is described or claimed therein.

A product named Chocolate Brittle Surprise having a base of soda crackers and a covering of chocolate was found at http://www.allrecipes.com/Recipe/Chocolate-Brittlle-Surprise on Mar. 31, 2009. It is not the chocolate brittle wherein the brittle is made of a batter containing chocolate.

A product which is a brittle with a chocolate topping is seen at http://www.giftsfromyourkitchen.com/brittle/chocolate-brittle.html. The brittle layer is made of sugar and butter which is covered with a topping of chocolate. The chocolate is not the brittle layer.

### SUMMARY OF THE INVENTION

It is the purpose of this invention to provide a brittle chocolate snack item that lacks the layering of chocolate on a brittle base and, instead, provides a snack wherein chocolate is a primary flavoring in the brittle. The compositions of the invention are made using a chocolate to syrup ratio of 1:1.5 to 3:1 chocolate to syrup. The product resulting from using the ingredients as described herein is made from a chocolate containing batter which provides a brittle which may, additionally, have thereon toppings such as dried fruit, bits of chocolate or candy and/or nuts which may be added to the batter or spread on top before or during baking.

### DETAILED DESCRIPTION OF THE INVENTION

It has now been found that use of chocolate such as that used in regular baking can be used to make brittle confections or snack items. The brittle (made from a batter): of the invention has base containing a ratio of 1:1.5 to 3:1 weight chocolate to weight of syrup, with a ratio of 1:1.5 to 2:1 being preferred in the base. The batter contains a fat. When using chocolate and butter or margarine, fat such as butter or margarine is at a ratio of about 2.5:1 to 5:1 weight to weight chocolate to fat and with a thickening agent, usually flour, at a weight to weight ratio chocolate to flour of 10:1 to 6:1. (The forgoing applies to the batter and assumes that chocolate will either be chocolate chips or chocolate bars. The ratios do not apply to additional ingredients which are not an integral part of the batter such as candies or chips that may be sprinkled on the base or folded into the batter but remain as discrete forms within the batter) The flour used was all purpose white wheat flour. Other thickening agents than such flour can be used. An example of another thickening agent is corn starch, which would be used at a similar weight to weight ratio as flour (though volume would differ, since corn starch is more dense than white wheat flour). Toppings such as chocolate chips, candy bits, dried fruits and nuts can be placed on the brittle before or during the baking process and the base can be flavored with any number of flavorings. The brittles of the invention may, but need not, contain sugar. Whether or not sugar is added will depend on the taste required, the amount of sugar in the chocolate used in making the brittle, and the, sweetness of any additions such as candy or dried fruit added to the brittle. Syrups of any kind, including maple syrup or syrup prepared by heating sucrose with water, may be used so long as the flavor does not overwhelm the chocolate flavor. However, when very sweet syrup is used, such as that known as golden syrup in Great Britain, it is usually preferred that added sweetness in the form of sugar be avoided. When added, the eggs act as a binding agent and improve the quality of the product. If desired, the eggs, to the extent they provide moisture to the batter, can be replaced with other fluid such as cream. However, incorporation of eggs gives the better product.

### Materials and Methods:

The preferred chocolate for use in the method of the invention is solid at room temperature but melts at temperatures usually used to melt baking chocolate. While many of the recipes are given using chocolate chips, any bar chocolate for use in baking or as a treat can be used. The 70% to 90% chocolate such as the 72% Trader Joe's PoundPlus™ dark chocolate (500 g) imported from Belgium provides a very rich, less sweet product. The brittles of the invention are baked and do not require cooking before baking. They are very thin. The following examples illustrate the invention, and are not meant as limitations. Similarly, it is possible to use cocoa powder when the amount of fat is increased. However, the best product is obtained using the bar chocolate.

Several of the spices used in the brittles were obtained from Spice Barn in Lewis Center, Ohio.

It is also possible to replace the chocolate with cocoa powder, replacing each ounce of chocolate with 3 tablespoons of cocoa and increasing fat in the primary mixture by ½ to 2 tablespoons of fat for each ounce of chocolate that is replaced. However, the end product, when using cocoa powder, is more wafer-like and less brittle. When the powder is used, the cocoa As mixed with the melted fat. Briefly, the method of preparation involves mixing chocolate or cocoa powder and a fat together, adding thereto a thickening agent and beaten eggs, then adding syrup to the mixture, then spreading the batter in a pan and baking.

Most generally, the process, when using chocolate chips or bars, consists of melting chocolate (baking chocolate, chocolate chips, chocolate bars) and a source of fat (preferably one which is solid but not hard at room temperature, such as butter or margarine) together. A mixture of flour and rising agent such as baking soda or baking powder (rising agent not essential), with salt, if desired, is prepared. Eggs (beaten) or egg substitute (14 eggs per 16 ounces of chocolate) and sugar (if any) along with the flour mixture and syrup, are added to the chocolate/butter mixture to form the brittle in any sequence provided, however, that it is preferable to add the syrup last along with any extracts used. Various ingredients may be added or, for particular diets, omitted, such as salt. Sugar substitutes may be used sparingly in place of sugar to add sweetness.

In this application, the “base” refers to the mixture containing chocolate (or cocoa powder), fat, eggs, flour and syrup with flavorings incorporated therein by mixing. Most “toppings” are added either before or during the baking process. Additions such as nuts, dried fruit, fruit peels, crushed candies or chips may be sprinkled on the mixture after it has been spread on the sheets.

### EXAMPLE 1

### A General Recipe Using Chocolate Chips

2 cups chocolate chips (16 ounces)
⅓ cup butter
2 eggs
½ cup sifted flour
½ teaspoon baking soda
¼ teaspoon salt
1½ cups corn syrup

### Mixing Process

While the ingredients may be added in various sequences, depending on the equipment available, the following method has proven reliable. The semi-sweet chocolate chips and the butter are melted over boiling water or, in the alternative, are placed in a microwave on defrost for 5 minutes until chips are melted. The butter and chocolate is stirred until well mixed. Beaten eggs and mixed dry ingredients are then added to chocolate mixture. The syrup is added last along with the flavorings.

### Baking Process

The batter mixture is spread evenly onto a shallow pan (To obtain the preferred thickness, the mixture prepared by the above method in the amounts given above will be spread over a surface of about 4-10 square feet, with most preferred spread over 5-6 square feet.) Pans may be tapped on the counter surface to remove air bubbles. The batter is baked at a temperature that will not burn the chocolate. Preferred temperature range is 325° to 375° F. As to toppings, if used, they may be sprinkled evenly over the base at this time or after the batter is partially baked. Baking time is about 12 to 15 minutes. It is also possible to sprinkle any additional toppings such as chips, dried fruit or nuts over partially baked base after 5-10 minutes, then return the oven to complete baking. After baking, it is best to cool completely before removing from pan. Peel off baking paper (if used) and break brittle into pieces.

### EXAMPLE 2

Either before or about half way through the baking process sprinkle 1½ to 2 cups of chocolate bits on top of brittle.

### EXAMPLE 3

Prepare mixture as above in example 1, but add, along with the syrup, 1-2 tablespoons peppermint extract. Otherwise, mix and bake in accord with instructions in example 1. Crushed peppermint candy may be sprinkled over the base either before baking or at about midway through the baking process.

### EXAMPLE 4

Replace the peppermint extract in example 3 with 1-2 tablespoons orange extract, which is added with the syrup to the base mixture. If desired orange rind may be added before or at some point during the baking process.

### EXAMPLE 5

In Example 1, but add, along with the syrup, two tablespoons cinnamon extract. Additionally, 1½ cups of chocolate chips or cinnamon chips may be sprinkled over the base either before baking or about half way through the baking process.

### EXAMPLE 6

In Example 2, replace the peppermint extract added to the syrup with 2 tablespoons rum flavoring.

### EXAMPLE 7

In Example 1, with syrup, add 2 teaspoons of brandy flavoring.

### EXAMPLE 8

Prepare in accord with Example 2, replacing chocolate chips sprinkled on the base with peanut butter chips.

### EXAMPLE 9

In Example 1, add to the melted chocolate chips and butter 2 tablespoons of instant coffee or, with the syrup, 2 teaspoons of coffee extract.

### EXAMPLE 10

In Example 1, sprinkle with 1½ cups butterscotch chips either before or after about half the baking time, then continue baking.

### EXAMPLE 11

In example 1, add, with syrup, 2 tablespoons raspberry extract. Additionally, chocolate chips or crushed raspberry candy may be spread over the base before or during the baking period.

### EXAMPLE 12

### Basic Method Using Baking Chocolate Bar

About 16 ounces Trader Joe's PoundPlus™ dark chocolate (72% chocolate)
⅓ cup butter
2 eggs
½ cup sifted flour
½ teaspoon baking soda
1/4 teaspoon salt
1½ cups corn syrup

### Mixing Process

Melt chocolate and butter. Remove from heat and stir until mixed well. Beat eggs and add to partially cooled melted chocolate/butter. Mix flour, baking soda and salt. Add to melted chocolate containing mixture and stir well. Add corn syrup and mix well. (Extracts and flavorings are added with syrup.)

The particular 72% chocolate used in this recipe gives a very richly flavored product. Some may desire more sweetness, in which case sugar may be added at the time the eggs are added to the mixture for the base. Remaining chocolate was crushed and spread over the base.

### EXAMPLE 13

Prepared as for example 12, but added ¼ to ⅓ cup instant coffee to the chocolate/butter mixture as it cools, preferably before adding the eggs.

### EXAMPLE 14

Prepare as in example 12, but added, with the syrup, two tablespoons pina colada flavoring. One may, additionally, sprinkle shredded coconut (roasted or unroasted) over the base before or during baking time.

### Example 15

Prepared as in example 12, but added, with the syrup, 2 tablespoons banana extract.

### EXAMPLE 16

Prepared as in example 13, but added, with syrup, 2 tablespoons of key lime extract.

### EXAMPLES 17 TO 26

Other flavorings that have been added with syrup to make desired flavors include, in the alternative, 2 tablespoons wild cherry extract, 2 tablespoons macadamia flavoring, two tablespoons amaretto flavoring, 2 tablespoons pineapple flavoring, 2 tablespoons maple flavoring, 2 tablespoons lemon extract, 2 tablespoons egg nog flavoring, 2 tablespoons caramel flavoring, two tablespoons vanilla extract or 1-2 tablespoons hot chili flavoring. The product having hot chili flavoring had a particularly sharp and distinct flavor.

### EXAMPLES 27 and 28

Combinations that have been added with the syrup include, in the alternative, 1 tablespoon rum extract with 1 tablespoon mint extract or one tablespoon butter flavoring with 1 tablespoon rum extract.

### EXAMPLE 29

### Cream Cheese Chocolate Brittle

3½ cups semi-sweet chocolate chips or 500 g bar chocolate
⅓ cup butter
2 eggs
4 ounces cream cheese
½ cup sifted flour
½ teaspoons baking soda
½ teaspoon salt
1½ cups corn syrup.

### Method:

Butter, chocolate and cream cheese were melted together with stirring to mix. After partially cooling; 2 beaten eggs were added followed by addition of a mixture of flour, soda and salt. Syrup was stirred into the mixture, which was then baked 12-14 minutes. Chocolate bits or other toppings may be added as in example 2.

### EXAMPLE 30

Prepare the batter as disclosed in examples 1 or 12. Sprinkle crushed toffee candy over the batter before baking.

### EXAMPLE 31

Prepare batter as disclosed in examples 1 or 12. Sprinkle with cinnamon chips. before baking.

Flavorings and toppings as disclosed herein are not deemed limiting, since any flavoring may be added to the brittle batter. While extracts of liquid flavorings were the primary flavorings incorporated into the examples of batters, powders and oils of flavoring components may be used instead.

The intensity of the flavoring of the brittle depends on the kind of chocolate used and the added flavorings. Flavorings such as chili and cardamom are particularly appreciated by Hispanics (chili) and Asians and persons from the Middle East. (cardamom). Powders may be used in place of extracts as exemplified herein. Allspice, Anise, Pepper and cloves are other suggestions.

1. A brittle chocolate food item having a base prepared from a batter which produces a brittle base wherein said batter contains chocolate and syrup at a ratio of 1:1.5 to 3:1 weight to weight chocolate to syrup, said batter containing, additionally, a fat wherein chocolate which is part of said batter has been melted, said batter containing, additionally, a thickening agent.

2. The food item of claim 1 containing, additionally, eggs.

3. The food item of claim 1 wherein the thickening agent is flour.

4. The food item of claim 1 which contains, additionally, an extract or flavoring.

5. The food item of claim 4 having one or more extracts or flavorings chosen from among peppermint, rum, cinnamon, orange, brandy, pina colada, coffee, banana, key lime, cherry, macadamia, amaretto, pineapple, maple, lemon, egg nog, caramel, vanilla, hot chili, cardamom and cloves.

6. The food item of claim 1 having, additionally, sprinkled thereon at least one topping chosen from among candy, fruit, nuts, or chips.

7. The food item of claim 6 wherein the toppings are chosen from among crushed candy, coconut and peanut butter, butterscotch, or chocolate chips.

8. The food item of claim 1 having sprinkled thereon coconut.

9. A method of preparing a chocolate brittle comprising the steps of:
(a) melting chocolate or cocoa powder and a fat together,
(b) adding thereto a thickening agent, then
(c) adding syrup to the product of (b),
(d) spreading the product of step (c) in a pan and baking.

10. The method of claim 9 wherein, after step (a) and with step (b) there is, additionally, added to the batter, an egg.

11. The method of claim 9 wherein the chocolate melted is bar chocolate.

12. The method of claim 9 wherein, in step (d), after spreading the batter in the pan, dried fruit, fruit peel, nuts, crushed candy or chips are sprinkled over the batter before baking.

13. The method of claim 9 wherein, in step (d), the pans are removed from the oven during the baking process in order to sprinkle dried fruit, fruit peel, nuts, crushed candy or chips over the batter followed by resumption of baking.

14. The food item of claim 1 wherein the batter contains cream cheese.

15. The food item of claim 1 having toffee candy sprinkled thereon,

16. The food item of claim 1 wherein the batter contains chili extract or powder.

17. The food item of claim 1 wherein the chocolate used in making said food item is cooking chocolate.
